(19) United States
(12) Patent Application Publication
(10) Pub. No.: US 2009/0141923 A1
(43) Pub. Date: Jun. 4, 2009

(54) EARPIECE WITH ATTACHED SPEAKER

(76) Inventor: Richard C. Smith, Costa Mesa, CA (US)

Correspondence Address: Haynes and Boone, LLP;IP Section, 2323 Victory Avenue, SUITE 700, Dallas, TX, 75219, US

(21) Appl. No.: 11/868,720

(22) Filed: Oct. 8, 2007

Related U.S. Application Data
(63) Continuation-in-part of application No. 11/411,314, filed on Apr. 26, 2006.
Application No. 11/411,314 is a continuation-in-part of application No. 11/247,105, filed on Oct. 11, 2005.

(51) Int. Cl. H04R 25/00

(52) U.S. Cl. 381/371

(57) ABSTRACT

An earpiece assembly for use with two-way radios and the like is disclosed. The earpiece assembly can include an earpiece and a speaker attached to the earpiece. Optionally, an insert such as a flanged insert can extend from the earpiece. The insert can be configured to be disposed within the ear canal. The earpiece and flange can be formed of a flexible and resilient material such as silicon rubber. Optionally, a microphone can also be attached to the earpiece. A housing can contain the microphone and/or speaker. By attaching the microphone and/or speaker to the earpiece, the use of acoustic tubing can be avoided.

### RELATED APPLICATIONS

This patent application is a continuation-in-part (CIP) patent application of U.S. patent application Ser. No. 11/411,314, filed on Apr. 26, 2006, and entitled EARPIECE WITH EXTENSION (docket no. M-15744-1P US), which is a continuation-in-part (CIP) patent application of U.S. patent application Ser. No. 11/247,105, filed on Oct. 11, 2005, and entitled EARPIECE WITH FLANGED EXTENSION (docket no. M-15744 US), the entire contents of both of which are hereby expressly incorporated by reference.

### TECHNICAL FIELD

The present invention relates generally to earpieces. The present invention relates more particularly to an earpiece with an attached microphone and/or speaker for use with communications equipment (such as two-way radios and cellular telephones) as well as for use with music players (such as MP3® players and ipods®) and the like.

### BACKGROUND

Earpieces for use by police, firemen, soldiers and security personnel are well known. Such earpieces are commonly used to facilitate listening to two-way radios. The earpieces allow the police, firemen, soldiers, and security personnel to hear important communications that may affect their safety and/or the safety of others.

An earpiece typically fits within the outer ear, i.e., the conchae, and is connected to a radio by a communications link, which comprises the combination of a length of acoustic tubing and a length of electrical cable. The acoustic tubing extends from the earpiece to a small speaker. The electrical cable extends from the speaker to the radio.

Thus, electrical signals from the radio travel via the electrical cable to the speaker, where they are converted into acoustic signals. The acoustic signals then travel via the acoustic tubing from the speaker to the earpiece, from which the acoustic signals are directed to the eardrum so that they can be heard. Generally, the acoustic tubing proximate the earpiece will be coiled, so as to readily provide a desired length of tubing while at the same time taking up any slack.

Although such contemporary dedicated earpieces have proven generally suitable for their intended purposes, they possess inherent deficiencies that detract from their overall effectiveness and desirability. For example, contemporary acoustic tubing generally has an outer diameter of approximately one eighth of an inch. Such diameter is sufficiently large so as to make the acoustic tubing obtrusive and uncomfortable to wear. Further, the use of acoustic tubing inherently alters the sound traveling therethrough. As sound travels through acoustic tubing, the intensity and quality of the sound is reduced. Therefore, it is desirable to eliminate the use of acoustic tubing in such applications.

### BRIEF SUMMARY

Systems and methods are disclosed herein to facilitate listening to two-way radios, cellular telephones, music players (such as MP3® players and iPods®), and the like. For example, in accordance with an embodiment, an earpiece assembly can comprise an earpiece and a speaker attached to the earpiece. Optionally, a microphone can also be attached to the earpiece. The microphone can be disposed within the housing, upon a boom, or at any other desired location (such as fastened to a user's lapel).

More specifically, in accordance with an embodiment the speaker and/or the microphone can be disposed within a housing that is attached to the earpiece. The housing can be made of a metal such as aluminum or can be made of a durable plastic.

In accordance with an embodiment, a method for assembling an earpiece assembly can comprise inserting an outer end of a flanged insert into a hole on an inner side of an earpiece and subsequently inserting a barbed fitting of a housing through a hole on an outer side of the earpiece and into a bore of the flanged insert. Thus, the earpiece can be captured intermediate the insert and the housing (which are attached to one another via the barbed fitting).

By attaching the microphone and/or speaker to the earpiece, the need for acoustic tubing can be eliminated. Sound intensity and quality can be improved because the speaker provides sound more directly to the ear. The earpiece assembly can be lighter, more comfortable to wear, and less conspicuous.

This invention will be more fully understood in conjunction with the following detailed description taken together with the following drawings.

### BRIEF DESCRIPTION OF THE DRAWINGS

FIG. 1 is a semi-schematic perspective view of an earpiece assembly defined by an earpiece with an attached speaker according to an exemplary embodiment of the present invention;

FIG. 2 is a semi-schematic perspective view of the earpiece assembly of FIG. 1, showing the flanged insert and housing exploded away from the earpiece and showing a microphone/speaker in dashed lines within the housing;

FIG. 3 is a semi-schematic enlarged perspective view of the earpiece of FIG. 1;

FIG. 4 is a semi-schematic enlarged perspective view of the insert of FIG. 1;

FIG. 5 is a semi-schematic enlarged perspective view of the housing of FIG. 1; and

FIG. 6 is a semi-schematic perspective view of an earpiece assembly having a boom microphone attached to the housing thereof.

Embodiments of the present invention and their advantages are best understood by referring to the detailed description that follows. It should be appreciated that like reference numerals are used to identify like elements illustrated in one or more of the figures.

### DETAILED DESCRIPTION

A method and system for enhancing communications are disclosed. According to an embodiment, an earpiece assembly comprises an earpiece and a speaker attached to the earpiece. Attachment of the speaker to the earpiece eliminates the need for acoustic tubing. The elimination of the acoustic tubing makes the earpiece assembly smaller, lighter, more comfortable, and less conspicuous. The attached speaker can facilitate use of the earpiece assembly in the reproduction of sound, such as for a cellular telephone, a two-way radio, or a music player (such as an MP3® player or an iPod®).

The earpiece assembly can further comprise a housing within which the speaker is disposed and via which the speaker is attached to the earpiece. The housing can be formed of a metal such as aluminum. Alternatively, the housing can be formed of a polymer such as ABS or polycarbonate. Indeed, the housing can comprise any desired combination of materials. For example, the body of the housing can comprise aluminum and the cap of the housing can comprise ABS.

According to an embodiment, the earpiece assembly can comprise a microphone either in addition to or in place of the speaker. The use of a microphone facilitates the use of the earpiece assembly in two way communications, such as via a cellular telephone or a two-way radio. A single transducer can function as both a microphone and a speaker.

The microphone and speaker can be disposed within the same housing. Alternatively, the microphone and speaker can be disposed within separate housings. The microphone can be disposed upon a boom. For example, the microphone can be disposed upon a boom that extends from the housing to a point proximate a corner of the user's mouth. The microphone can be disposed at a point approximately one half of the way between the housing and the corner of the user's mouth.

One or more cables can extend from the housing so as to effect electrical communication with the microphone and/or speaker. For example, an electrical cable containing two pairs of wires can extend from the housing to a two-way radio. One pair of wires can communicate received voice from the radio to the speaker and the other pair of wires can communicate voice from the microphone to the radio.

The earpiece can be comprised of a resilient polymer material. For example, the earpiece can be comprised of rubber, such as silicon rubber. The earpiece can be comprised of a resilient material having a Shore A durometer of between approximately 35 and approximately 45, such as a material having a Shore A durometer of approximately 40.

An insert can be attached to the earpiece. The insert can have one or more flanges. For example, the insert can have one, two, three, four, five, or more flanges. Alternatively, the insert can have no flanges.

The insert can be comprised of a resilient polymer material. For example, the insert can be comprised of rubber, such as silicon rubber. The insert can be comprised of a resilient material having a Shore A durometer of between approximately 35 and approximately 45, such as having a Shore A durometer of approximately 40.

The housing can be attached to the earpiece via a friction fit, adhesive bonding, ultrasonic welding, or any other desired method. The housing can be water resistant so as to protect the microphone and/or speaker disposed therein from water damage.

The speaker can comprise a balanced armature speaker. Alternatively, the speaker can be any other desired type of speaker.

According to an embodiment, the earpiece assembly can comprise an insert attached to one side of the earpiece via a friction fit and a housing having a barbed fitting attached to another side of the earpiece by inserting the barbed fitting through the earpiece and into the insert. Thus, the barbed fitting of the housing can attach the housing, earpiece, and insert to one another. Adhesive bonding, ultrasonic welding, and/or any other method can be used to enhance such attachment.

The earpiece and the insert can be integrally formed with one another. The earpiece and the insert can be formed of the same material. Similarly, the earpiece, the insert, and the housing can be integrally formed with one another. The earpiece, the insert, and the housing can be formed of the same material.

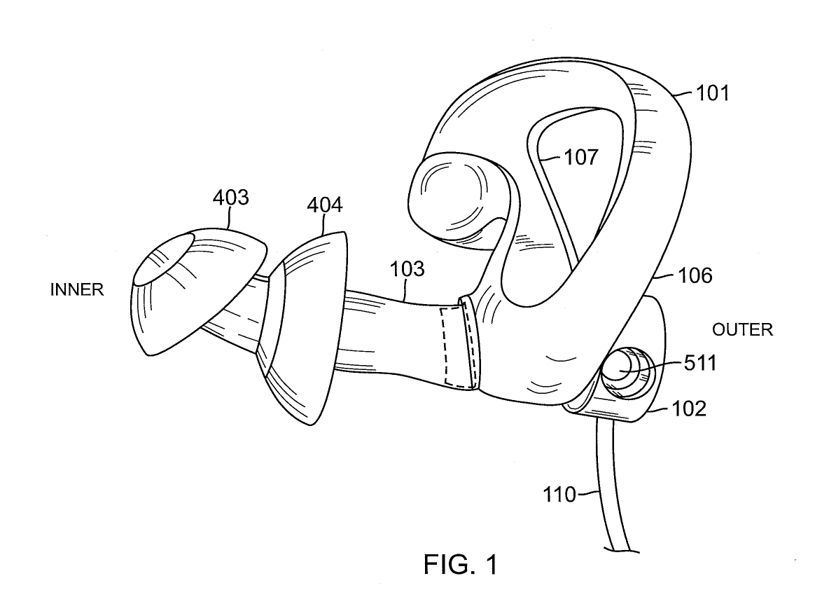

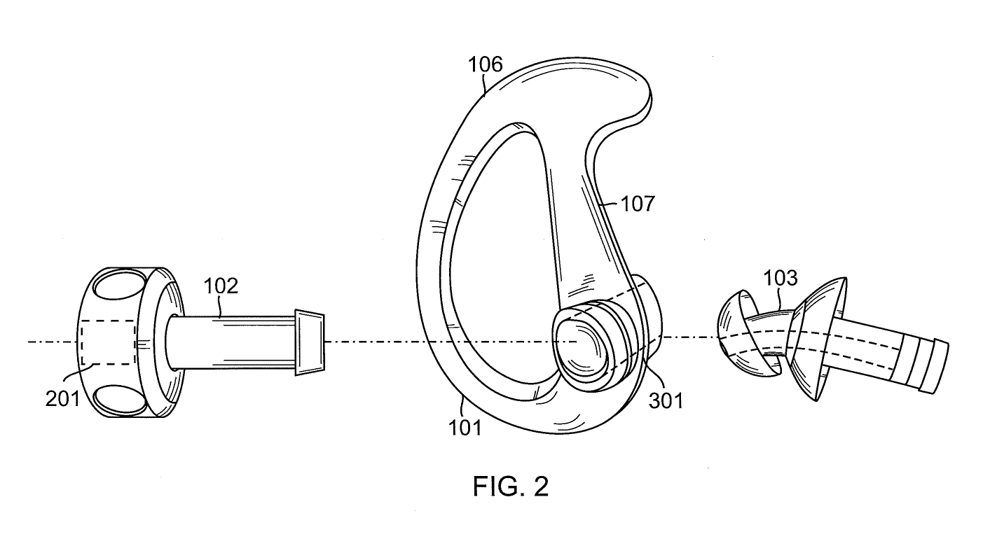

Referring now to FIGS. 1 and 2, an earpiece 101 can have a speaker 201 (FIG. 2) attached thereto. The earpiece 101 can be configured to fit within a conchae of a user's ear. The speaker 201 can be disposed within a housing 102 and can be attached to the earpiece 101 via the housing 102. The housing 102, and consequently the speaker 201, can be disposed within the conchae, outside of the conchae, or partially inside and partially outside of the conchae. Optionally, the housing 102 can be omitted and the speaker 201 can be attached more directly to the earpiece 101.

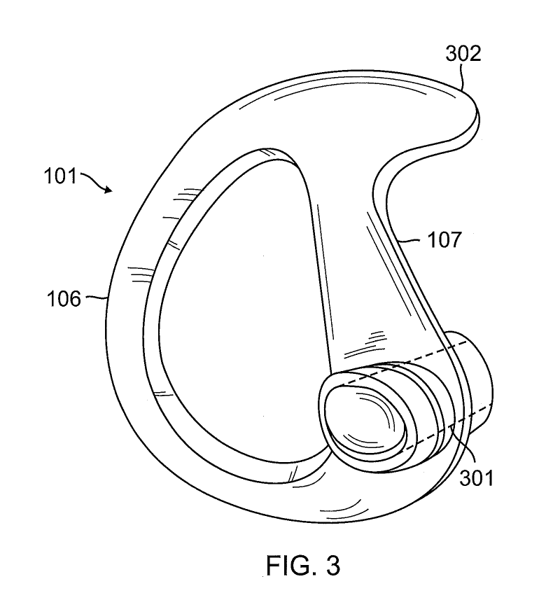

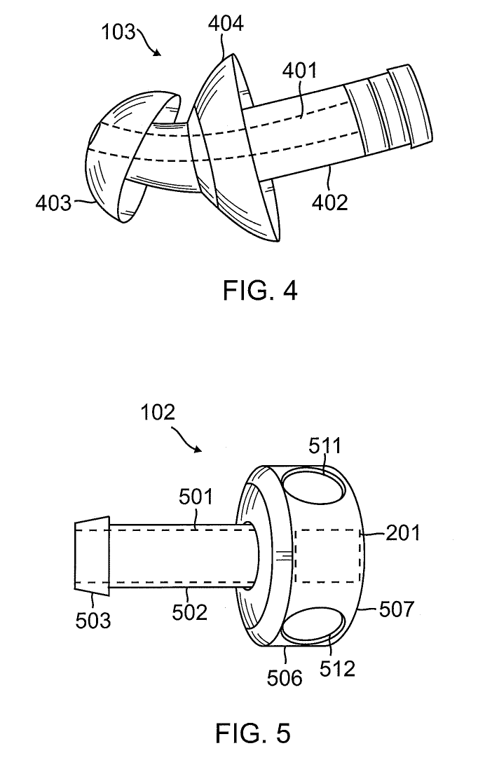

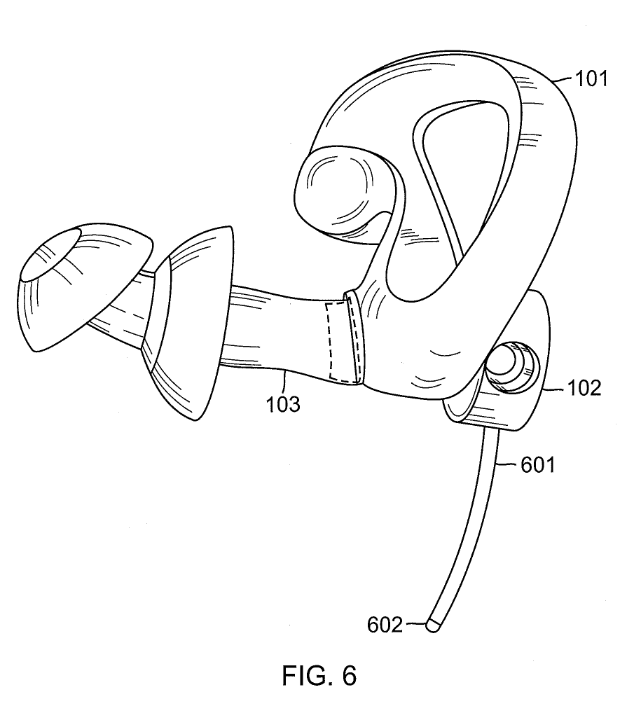

Optionally, an insert 103 can be attached to the earpiece 101. The insert can be configured to extend into a user's ear canal. The insert 103 can be configured so as to direct sound from the speaker 201 through the ear canal to the eardrum of a user. For example, sound from the speaker 201 can travel through a bore (501 of FIG. 5) of the housing 102, though an opening (301 of FIGS. 2 and 3) in the earpiece 101, and through a bore (401 of FIG. 4) in the insert 103.

An electrical cable 110 can extend from housing 102. The cable 110 can comprise a plurality of conductors for communicating electrical signals representative of sound with the microphone and/or speaker of the earpiece assembly.

Microphone/speaker 201 can comprise a microphone, a speaker, and/or electronic circuitry. Such electronic circuitry can comprise an attenuator, amplifier, filter, or other sound processing circuitry. Such circuitry can comprise a microprocessor and/or digital sound processing circuitry.

Microphone/speaker 201 can comprise a wireless microphone that receives a radio signal and converts the radio signal into sound. The radio signal can be received from a local source and/or a remote source. The radio signal can be received from a local source such as the user's own two-way radio. For example, the speaker output of the user's two-way radio can be re-modulated and transmitted to the microphone/speaker 201 so as to define a wireless link between the two-way radio and the microphone/speaker 201.

The radio signal can be received from a remote source such as a remotely located two-way radio (someone else's two-way radio). In this manner, someone else can communicate covertly with the user (the user does not need to carry a two-way radio).

Referring now to FIG. 3, the earpiece 101 can have a generally arcuate rib 106 and a generally straight rib 107 that cooperate to hold the earpiece 101 within the conchae of a user's ear. Generally arcuate rib 106 and generally straight rib 107 can be configured so as to define a likeness of the letter D.

Bore 301 can extend through a portion of the generally straight rib 107, such as proximate where the generally straight rib 107 joins the generally arcuate rib 106 at the lower portion thereof. Sound can pass though bore 301. A portion of insert 103 and/or housing 102 can pass though bore 301.

The earpiece 101 can have a lobe 302 formed at the top thereof. Optionally, the earpiece 101 can have a similar lobe (not shown) formed at the bottom thereof. Typically, the top lobe 302 will be larger than a bottom lobe, if present.

Referring now to FIG. 4, the insert 103 can have a stem 402 that has one or more flanges 403 and 404 formed thereon. The inner flange 403 can be smaller than the outer flange 404, so as to better conform to the shape of a user's ear canal.

Bore 401 can facilitate the transmission of sound through the insert 103 toward the user's eardrum. Bore 401 can also facilitate the insertion of barbed tube 502 (FIG. 5) of housing 102 therein so as to attach the housing 102 to the insert 103.

Referring now to FIG. 5, a housing 102 for the microphone and/or speaker 201 can comprise a body 506, a cap 507, and a stem 502. The microphone and/or speaker 201 can be disposed within the body 506, such as within a cavity therein. The cap 507 can seal the microphone and/or speaker 201 within the body 506. The cap 507 can be attached to the body 506 by threads, adhesive bonding, welding, soldering, brazing, ultrasonic welding, friction fit, snap fit, detents, friction welding, or by any other desired method.

One or more apertures 511 and 512 facilitate the introduction of conductors, e.g., electrical cables, into the housing 102 so as to provide electrical communication between the microphone and/or speaker 201 and a radio or the like. Apertures 511 and 512 can be used to mount boom microphone (602 of FIG. 6).

The housing 102 containing the microphone and/or speaker 201 can be attached to the earpiece 101 and the insert 103 as shown in FIG. 1. Alternatively, the housing 102 can be attached to the earpiece 101 and the insert 103 can be omitted. As a further alternative, the housing 102 can be attached to the insert 103, and the earpiece 101 can be omitted.

The microphone and/or speaker 201 can be attached to the earpiece 101 and/or the insert 103 without the use of a housing. For example, the microphone and/or speaker 201 can be attached to or embedded within the earpiece 101 and/or the insert 103. The microphone and/or speaker 201 can be attached to or embedded within the earpiece 101 and the insert 103 can be omitted. The microphone and/or speaker 201 can be attached to or embedded within the insert 103, and the earpiece 101 can be omitted.

One or more barbs 503 can be formed upon tube 502, such as upon the inner end thereof, so as to facilitate secure attachment of housing 102 to earpiece 101 and/or insert 103. The barb(s) 503 can engage the bore 401 of insert 103. Other means for facilitating secure attachment of the housing 102 to the tube 502 can be used. For example, threads can be formed upon the tube 502 for securely attaching the tube 502 into the bore 401 of insert 103.

Referring now to FIG. 6, a boom mike 602 can be mounted to the distal end of boom 601. The boom 601 can be attached to housing 102, such as via one of the apertures 511 and 512. The boom 601 can be attached to housing 102 via threads, adhesive bonding, or any other desired method. The boom 601 can alternatively be attached to the earpiece 101 and/or the ear insert 103.

Boom microphone 602 can be used with or instead of the microphone disposed within housing 102. Thus, either microphone can be used alone or both microphones can be used together.

The microphone disposed within housing 102 can be used to provide processed, e.g., amplified and/or filtered, ambient sound to the user (in a manner similar to that of a hearing aid) and the boom microphone 602 can be used to provide voice from the user to a two-way radio or cellular telephone. The microphone disposed within housing 102 can be use to provide voice from the user to a two-way radio or cellular telephone.

The boom 601 can be a telescoping boom. The use of a telescoping boom readily facilitates changes in the length thereof, so as to facilitate desired placement of the microphone 602. The boom 601 can be a bendable boom. The use of a bendable boom readily facilitates changes in the position of the distal end thereof, so as to facilitate desired placement of the microphone 602.

According to an embodiment, a method for assembling an earpiece assembly comprises inserting an outer end of a flanged insert into a hole on an inner side of an earpiece and inserting a barbed fitting of a housing though a hole on an outer side of the earpiece and into a bore of the flanged insert.

One or more embodiments eliminate the use of acoustic tubing so as to provide enhanced audio quality to the user. Elimination of acoustic tubing tends to provide a higher intensity audio signal to the user because sound is not attenuated by the acoustic tubing. Thus, the volume of the radio, cellular telephone, music player or the like can be reduced. A smaller, lower wattage speaker can be used since the speaker does not required the additional power necessary to compensate for attenuation caused by acoustic tubing.

The elimination of acoustic tubing also facilitates the construction of a smaller, lighter, more comfortable, and less conspicuous earpiece assembly. The earpiece assembly is smaller and lighter because it does not have the extra weight and bulk of the acoustic tubing.

The earpiece assembly is more comfortable because the electrical cable that passes over the ear to communicate a signal representative of sound is substantially smaller than acoustic tubing. Acoustic tubing can be one-eighth of an inch in outer diameter. Electrical cable 110 can be one thirty-second of an inch to one-sixteenth of an inch in outer diameter, or even smaller. The use of such smaller electrical cable in place of the larger acoustic tubing makes the earpiece assembly substantially less obtrusive and conspicuous.

Embodiments described above illustrate, but do not limit, the invention. It should also be understood that numerous modifications and variations are possible in accordance with the principles of the present invention. Accordingly, the scope of the invention is defined only by the following claims.

1. An earpiece assembly comprising:
an earpiece; and
a speaker attached to the earpiece.

2. The earpiece assembly as recited in claim 1, further comprising a housing via which the speaker is attached to the earpiece and wherein the speaker is disposed within the housing.

3. The earpiece assembly as recited in claim 1, further comprising a metal housing via which the speaker is attached to the earpiece and wherein the speaker is disposed within the housing.

4. The earpiece assembly as recited in claim 1, further comprising an aluminum housing via which the speaker is attached to the earpiece and wherein the speaker is disposed within the housing.

5. The earpiece assembly as recited in claim 1, further comprising a plastic housing via which the speaker is attached to the earpiece and wherein the speaker is disposed within the housing.

6. The earpiece assembly as recited in claim 1, further comprising a microphone attached to the earpiece.

7. The earpiece assembly as recited in claim 1, further comprising:
a housing attached to the earpiece;
a microphone; and
wherein the speaker and the microphone are disposed within the housing.

8. The earpiece assembly as recited in claim 1, further comprising conductors extending from the housing via which an electronic signal representative of sound is provided to the speaker.

9. The earpiece assembly as recited in claim 1, wherein the earpiece is comprised of a resilient polymer material.

10. The earpiece assembly as recited in claim 1, wherein the earpiece is comprised of rubber.

11. The earpiece assembly as recited in claim 1, wherein the earpiece is comprised of silicon rubber.

12. The earpiece assembly as recited in claim 1, wherein the earpiece is comprised of a resilient material having a Shore A durometer of between approximately 35 and approximately 45.

13. The earpiece assembly as recited in claim 1, wherein the earpiece is comprised of a resilient material having a Shore A durometer of approximately 40.

14. The earpiece assembly as recited in claim 1, further comprising an insert attached to the earpiece.

15. The earpiece assembly as recited in claim 1, further comprising an insert attached to the earpiece and wherein the insert is comprised of a resilient polymer material.

16. The earpiece assembly as recited in claim 1, further comprising an insert attached to the earpiece and wherein the insert is comprised of rubber.

17. The earpiece assembly as recited in claim 1, further comprising an insert attached to the earpiece and wherein the insert is comprised of silicon rubber.

18. The earpiece assembly as recited in claim 1, further comprising an insert attached to the earpiece and wherein the insert is comprised of a resilient material having a Shore A durometer of between approximately 35 and approximately 45.

19. The earpiece assembly as recited in claim 1, further comprising an insert attached to the earpiece and wherein the insert is comprised of a resilient material having a Shore A durometer of approximately 40

20. The earpiece assembly as recited in claim 1, further comprising an insert attached to the earpiece, the insert having at least one flange formed thereon.

21. The earpiece assembly as recited in claim 1, further comprising an insert attached to the earpiece, the insert having a plurality of flanges formed thereon.

22. The earpiece assembly as recited in claim 1, further comprising an insert attached to the earpiece, the insert having two flanges formed thereon.

23. The earpiece assembly as recited in claim 1, further comprising a housing via which the speaker is attached to the earpiece and wherein housing is attached to the earpiece via a friction fit.

24. The earpiece assembly as recited in claim 1, further comprising a housing via which the speaker is attached to the earpiece and wherein housing is attached to the earpiece via adhesive bonding.

25. The earpiece assembly as recited in claim 1, further comprising a housing via which the speaker is attached to the earpiece and wherein housing is attached to the earpiece via ultrasonic welding.

26. The earpiece assembly as recited in claim 1, further comprising a housing within which the speaker is disposed and wherein the speaker is water resistant.

27. The earpiece assembly as recited in claim 1, wherein the speaker comprises a balanced armature speaker.

28. The earpiece assembly as recited in claim 1, further comprising:
an insert attached to one side of the earpiece via a friction fit; and
a housing having a barbed fitting attached to another side of the earpiece by inserting the barbed fitting through the earpiece and into the insert.

29. The earpiece assembly as recited in claim 1, further comprising an insert integrally formed with the earpiece.

30. The earpiece assembly as recited in claim 1, further comprising:
a housing within which the speaker is disposed;
a boom extending from the housing; and
a microphone disposed upon a distal end of the boom.

31. The earpiece assembly as recited in claim 1, further comprising:
a housing within which the speaker is disposed;
a boom extending from the housing, the boom being configured so as to position a distal end thereof proximate a corner of a user's mouth; and
a microphone disposed upon the distal end of the boom.

32. The earpiece assembly as recited in claim 1, further comprising:
a housing within which the speaker is disposed;
a radio receiver disposed within the housing; and
wherein the radio receiver provides an output to the speaker.

33. An earpiece assembly comprising:
an earpiece;
a speaker; and
means for attaching the speaker to the earpiece.

34. The earpiece assembly as recited in claim 33 further comprising:
a microphone; and
means for attaching the microphone to the earpiece.

35. A method for assembling an earpiece assembly, the method comprising:
inserting an outer end of a flanged insert into a hole on an inner side of an earpiece; and
inserting a barbed fitting of a housing though a hole on an outer side of the earpiece and into a bore of the flanged insert.
